(19) United States
(12) Patent Application Publication
(10) Pub. No.: US 2026/0195224 A1
(43) Pub. Date: Jul. 9, 2026

(54) REPAIR FOR PARTIAL DATA LOSS IN A DATABASE AWARE DISTRIBUTED DATA STORE

(71) Applicant: Oracle International Corporation, Redwood Shores, CA (US)

(72) Inventors: Siddharth Choudhary, Belmont, CA (US); Jingtao Xu, Fremont, CA (US); Dongqiao Ma, San Jose, CA (US)

(21) Appl. No.: 19/013,291

(22) Filed: Jan. 8, 2025

(51) Int. Cl. G06F 11/20

(52) U.S. Cl. CPC G06F 11/2069; G06F 11/2058; G06F 2201/80

(57) ABSTRACT

For database high availability without data loss, a storage drive is resilvered in the background while all replicas of a database remain in service. A distributed system persists a first replica of a database in a first storage computer (SC) and a second replica of the database in a second SC. The database contains a database extent that contains a database block. An instance of the database block is persisted in a storage drive of the first SC. When data loss of the database block instance is discovered, the first SC increments a repair count of the database. While the first SC repairs the damaged database extent that includes the lost database block, a second SC detects that the repair count of the database exceeds a repair count in a write request, which causes the write request to be rejected in a way that indicates that the write request should be retried.

### FIELD OF THE DISCLOSURE

This disclosure relates to resilvering in the background without data loss while all replicas of a database remain in service for high availability.

### BACKGROUND

A database management system (DBMS) may involve a stack of infrastructure layers such as processing, persistence, and networking that may be more or less unreliable. Reliability, availability, and serviceability (RAS) may include high availability based on redundancy of replicas so that there is no single point of failure that can incapacitate the DBMS or its infrastructure stack. An outage of a replica may be planned or unplanned, and the outage may be due to an infrastructure component being temporarily or permanently unavailable. Database content may be persisted in an occasionally unreliable storage device such as a hard disk drive (HDD) or a solid state drive (SSD), and both kinds of storage drives may lose data.

The following are database performance benefits of using an SSD instead of an HDD. Faster data retrieval and reduced input/output (I/O) latency of an SSD lead to significantly improved query response times. Faster write operations to redo logs and undo tablespaces in an SSD result in quicker transaction commits. SSDs are more reliable than HDDs, which decreases the risk of data loss due to hardware failures and increases availability. While SSDs have a higher upfront cost, they often offer better performance, reliability, and energy efficiency, which can offset the initial expense over time and decrease total cost of ownership (TCO).

Regardless of reliability of a storage medium, data loss is possible. To mitigate the risk of data loss, the state of the art has the following various general data protection strategies. Creating regular backups of a database can help to recover lost data in case of a failure. Storing multiple copies (i.e. replicas) of data on different devices or in different locations can increase fault tolerance. Monitoring the health of replicas and alerting administrators to any potential issues can help to prevent data loss.

With HDDs and SSDs, scrubbing is a background process that scans the storage device for errors and bad sectors. This process is often performed automatically by the storage device's controller. By identifying and isolating bad sectors, scrubbing helps to prevent data loss and improve the overall reliability of the storage device. Physical defects on a disk surface can cause data to be unreadable, resulting in bad sectors. Individual flash cells or blocks can wear out (i.e. become defective over time), resulting in bad blocks. Thus, both disk and flash storage devices can experience bad regions due to physical defects or wear and tear.

Flash memory degradation occurs in an SSD due to a phenomenon known as write endurance. This means that each flash cell can only be written to a limited number of times before the cell starts to degrade. Degradation of a flash cell entails a progression of charge trapping followed by charge loss that causes data loss. Flash memory cells are made of floating-gate transistors. When data is written to a cell, electrons are trapped in the floating gate, creating a charge that represents the stored data. Over time, the trapped electrons can escape from the floating gate due to various factors discussed below. As charge is lost, the stored data becomes unreliable. Eventually, the cell may become completely unusable.

The following are distinct ways of charge loss that cause data loss. A tunnel effect is when electrons can quantum-mechanically tunnel through the insulating barrier between the floating gate and the channel. Hot carrier injection is when high-energy electrons are injected into the floating gate, causing charge loss. Program/erase cycling is when repeated write and erase operations stress the flash cells and accelerate charge loss.

The following are factors that increase flash memory degradation. The more times a cell is written to, the more likely it is to degrade. Higher write voltages can accelerate charge loss. Higher temperatures can increase the rate of charge loss. The quality (i.e. robustness, reliability) of the flash memory cells can vary depending on the manufacturing process.

The following are SSD degradation mitigation strategies in the state of the art. Wear leveling is a technique that distributes writes evenly across all cells to minimize the number of times any individual cell is written to. Error correction codes (ECC) can detect and correct errors caused by data corruption. Tailored Read/Modify/Write (TRIM) is a command that informs the flash drive about deleted blocks, allowing the drive to optimize its internal operations and reduce wear. Proper usage of an SSD may entail avoiding excessive write cycles and storing the flash drive in a cool, dry place to prolong its lifespan.

### BRIEF DESCRIPTION OF THE DRAWINGS

In the drawings:

FIG. 1 is a block diagram that depicts an example distributed system that resilvers in the background without data loss while all replicas of a database are in service;

FIG. 2 is a flow diagram that depicts two distinct concurrent example independent processes that two storage computers may respectively perform where one example process resilvers in the background without data loss while another example process maintains data coherence to keep all replicas of a database in service;

FIG. 3 is a flow diagram that depicts example activities that storage computer(s) may perform while a storage computer resilvers in the background without data loss while all replicas of a database remain in service;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

This disclosure relates to database high availability. Here is resilvering of a storage drive in the background without data loss while all replicas of a database remain in service. This approach is a new way of distributed data loss repair that has the following beneficial characteristics. This approach performs completely distributed repairs without global blocking (i.e. waiting). The amount of data that is repaired corresponds exactly to what is lost without overhead. Database server input/output (IOs) such as read/write/deletes or file operations such as file creation/deletion/resizing are not blocked during the repair of the lost data.

In a database aware distributed file system, a partial data loss can occur due to any of the following conditions that this approach well handles. A writeback cache failure may result in all dirty data in the cache being lost. An IO error discovered during reads due to disk rot or bad sectors on the storage device may cause data loss. Bad disk regions may be identified during background scrubbing activity that preemptively discovers potential bad sectors that cause data loss. In all of these cases, because there is a partial data loss, this approach reestablishes the lost data by reading a database mirror to obtain the lost data. However, reading an online mirror to fix the lost data entails novel coordination herein for incoming writes from the database server.

This approach is flexible enough to let a replicated database remain in service to, for example, handle any other disruption in the distributed system such as a rebalance or a resynchronization without blocking or waiting for a repair to finish. One example is a writeback cache failure. As soon as the failure is detected, this approach dumps a listing of all dirty cache lines that were in the cache for tracking the physical addresses that have lost data. This data loss information is stored in a persistent store, such as a disk filesystem file, so that the data loss information is available to throughout the entire repair duration.

This approach periodically checks in the background for existence of this data loss file that contains a lost physical address information table. When this file is detected, a repair in the background is initiated. During repair, a storage computer uses the lost physical address information table to detect: a) which database blocks are lost, and b) which database extents contain a lost database block. In other words, the storage computer detects which database extents that it stores are damaged (i.e. include a lost database block).

The total repair is divided into groups of damaged extents for acceleration. For acceleration, there is no global barrier herein. This approach entails only a barrier on a database extent that is damaged and, for acceleration, this barrier causes access request resending instead of waiting.

To repair a group of database extents, this approach first creates a local delta that is a persistent pseudo mirror of a database as discussed later herein. This local delta will temporarily and persistently hold all new writes or deletes that occur on a database extent while the database extent is being repaired. After a local delta has been created, if a database server needs to read a logical address, this approach first checks if there is any data in the local delta. If the local delta has some data that is being requested, this approach services as much of the read request using the local delta as possible. Reads of a database replica are allowed while a database extent in the database replica undergoes repair. This behavior provides a combination of a) a local delta intercepting updates for damaged extents being repaired and b) backed by a full database replica to provide a fully online mirror while also allowing for a read-only state of the damaged extent while it is being repaired.

This approach well handles the problem of reading a dirty mirror as a source for obtaining lost data. The reads from the repair source mirror are considered dirty herein because repair reads might be racing with database server writes on the repair source because the repair source itself is in service. This approach solves this racing problem by erecting what is referred to herein as a burning barrier on the repair source mirror which causes all writes and deletes that were already inflight to be discarded and retried by database servers on all mirrors unconditionally. Herein, a burning barrier is a barrier that, instead of causing waiting, causes an access request to be resent. Herein a mirror is a replica of a database.

The burning barrier ensures that the mirror being repaired has either already received a write or will receive the write again and store the write's payload in the local delta. This ensures that a write is never lost, no matter what is the status of damage or repair of a database extent. After the burning barrier is established, this approach reads all of the partially lost data by remotely reading the repair source mirror and writing the data locally. Herein, any data loss is only a partial data loss because the loss is limited to a particular storage computer and, in other storage computers, the same data is available and not lost.

After a database extent is fully repaired, this approach temporally blocks writes and deletes on only that repaired database extent and applies the local delta's content of that database extent, if any, to the real mirror thereby catching up (i.e. synchronizing) the real mirror and fixing any inconsistencies due to dirty data from a repair source mirror. Herein, the real mirror means the database replica that is being repaired, excluding the delta. After this, writes and deletes are unblocked and the repair has completed for the database extent.

This approach has at least the following innovations. This is a fully distributed partial data loss repair technique. All database server IOs and file operations are allowed (i.e. not blocked) during repair. This approach has minimal database server performance impact from the repair because writes and deletes are the only operations that are ever temporarily blocked and only just for the duration of the commit of the local ‘Delta’ (pseudo mirror) that tracked writes and deletes while the damaged extent was actively being repaired. Data loss detection, referred to later herein as discovery, may occur in the foreground during IO completion and triggering a repair without having to wait for background scrubbing code to detect the loss. Foreground discovery is an accelerating innovation herein. Likewise, more efficient disk scrubbing by scrubbing only materialized disk locations is another accelerating innovation herein. This approach has efficient repairs that are minimized by repairing exactly the location that had partial data loss. This approach can relocate or copy data with partial data loss by: a) interrupting an ongoing repair and b) relocating repair metadata and damaged data at the same time to another storage computer that c) resumes the repair.

This approach has at least the following advantages. The impact (e.g. blocking) on handling of any future failures such as resync or rebalance is avoided while repair is in progress. Information about what to repair is local to the storage computer that experiences the partial data loss, and a storage computer does not track data loss by other storage computers. A distributed repair only involves the storage computer that lost data and the storage computer that has the source mirror from which the lost data is read, and this minimizes a count of computers involved in the repair, thus reducing the amount of network messages exchanged in a distributed system.

### 1.0 Example Distributed System with Multiple Example Storage Computers

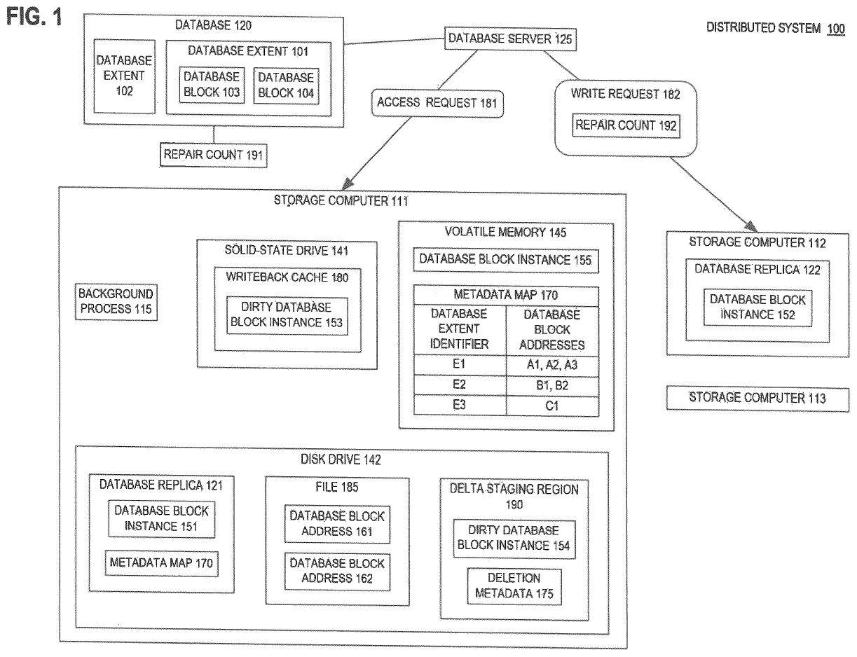

FIG. 1 is a block diagram that depicts example distributed system 100 that resilvers in the background without data loss while database replicas 121-122 of database 120 are in service. Each of storage computers 111-113 may be a rack server such as a blade, a mainframe, or other computing hardware. Although not shown, all computers in distributed system 100 are interconnected by one or more communication networks. For example, distributed system 100 may be contained in a datacenter or distributed across multiple datacenters. In an embodiment, distributed system 100 is part of a public or private cloud.

### 1.1 Database Server Can Use Many replicas of Database

Database replicas 121-122 are identical copies of database 120 that may, for example, be a relational database. Each of database replicas 121-122 is persisted in a disk drive of a respective distinct storage computer 111-112. For example, database replica 121 is stored in disk drive 142 in storage computer 111. Database 120 itself is a logical data structure that physically persists only as identical database replicas in disk drives of storage computers. Database server 125 itself contains only volatile memory copies of small portions of database 120. Database server 125 itself never contains whole database 120, which database server 125 has insufficient volatile memory for. Database server 125 is hosted by a computer that is not a storage computer.

Herein, database replicas 121-122 and storage computers 111-113 do not have asymmetric roles such as active or standby. Database server 125 may directly cooperate with either of storage computers 111-113 to access a replica of database 120. Database server 125 comprises a database management system (DBMS) that operates database 120 on behalf of client(s). For example, database server 125 may receive data manipulation language (DML) and data definition language (DDL) statements from clients and may use replicated database 110 for online transaction processing (OLTP).

### 1.2 Database Blocks and Device Blocks

The logical unit of persistence in database 120 is a fixed-size database block. The physical unit of persistence in storage drives 141-142 is a fixed-size device block, and storage drives 141-142 are block storage devices that store device blocks of a same size. In various embodiments depending on the ratio of database block size to device block size: a) a device block contains multiple database blocks, b) a database block spans multiple device blocks, or c) a device block and a database block have a same size.

Each database block is uniquely identified by a respective distinct database block address. Each of database block addresses 161-162, A1-A3, B1-B2, and C1 is a data structure that, in an embodiment, consists of data fields such as: a) a physical or logical block address (LBA) of a disk block that contains the database block and b) an identifier of a file, such as a serial integer, that contains the disk block. Herein, a disk block is a device block in a disk drive.

Because database 120 has multiple database replicas 121-122, each database block in database 120 has multiple database block instances. In some examples, database block instances 151-155 are copies of a same database block. In other examples, database block instances 151-155 are copies of distinct respective database blocks.

### 1.3 Data Access Requests

In the shown example, database server 125 sends access requests 181-182 to respective storage computers 111-112. Access requests 181-182 are shown as rounded rectangles to indicate that access requests 181-182 are data structures sent between two respective computers through a communication network. In one scenario, execution of a single SQL statement causes database server 125 to generate and send access requests 181-182. In another scenario, database server 125 generates and sends access requests 181-182 for respective SQL statements.

An access request is a read request or a write request. In one example, a read request contains database block addresses of one or more database blocks to read from database 120. In another example, a read request is a smart scan request that contains filtration criteria instead of a database block address. A write request contains database block addresses and contents of one or more database blocks to write into database 120.

### 1.4 Dirty Database Block in Persistent Cache With Writeback for Acceleration

For acceleration, storage computer 111 contains solid state drive 141 that contains writeback cache 180 that contains instances of multiple database blocks for reading and writing. If access request 181 is a read request, then access request 181 is accelerated when writeback cache 180 contains at least one database block accessed by access request 181. Solid state components 141 and 180 do not have capacity to store whole database replica 121.

In one example, access request 181 contains dirty database block instance 153 and causes persistence of dirty database block instance 153 into writeback cache 180, which may entail eviction, from writeback cache 180, of a database block instance of a different database block. Writeback cache 180 is a database block cache that is a persistent cache that may have an eviction policy such as least recently used (LRU).

Storage of dirty database block instance 153 into writeback cache 180 is not write through and does not cause dirty database block instance 153 to be stored into components 121 and 142. Disk drive 142 has rotational latency and seek latency that are avoided or deferred by not performing write through.

Database block instance 153 is dirty because it contains modified data that database replica 121 does not contain because the modified data has not been written back. For example, dirty database block instance 153 may be one version of database block 103 and, in some cases: a) neither of database replicas 121-122 contains that version of database block 103, or b) neither of database replicas 121-122 contains database block 103 that is a new database block. When dirty database block instance 153 is later written back, writeback cache 180 may, for acceleration of future read requests, retain database block instance 153 even though it is no longer dirty.

The effect of a latest write request to a database block is to entirely overwrite a previous version of the contents of the database block. In one scenario, dirty database block instance 153 is a previous version of a database block being overwritten by access request 181 that contains a new version of the database block. In another scenario, dirty database block instance 153 is the new version already written by access request 181 that contains a new version of the database block and, later, dirty database block instance 153 may be overwritten by a newer version by another write request. If dirty database block instance 153 is overwritten before dirty database block instance 153 is written back, then the writeback of dirty database block instance 153 is avoided, which accelerates components 111, 120-121, and 125.

### 1.5 Accelerated Eviction From Persistent Cache

Eviction of a database block causes writeback of the database block only if the database block is dirty. Herein and although not write through, deferred writeback of dirty database block instance 153 may eventually proactively occur based on eviction or writeback of a different database block. This proactive writeback of dirty database block instance 153 occurs without eviction of dirty database block instance 153 in the following ways that exploit data locality to coalesce writeback of multiple dirty database blocks into a single disk write to database replica 121. Coalescing extends the lifespan and mean time between failures (MTBF) of the magnetic recording surface of disk drive 142. Coalescing extends the lifespan and MTBF of the mechanically moving parts of disk drive 142.

In one scenario, one disk block contains two database blocks, and writeback cache 180 contains dirty database block instances of both database blocks. When writeback cache 180 selects one of the two dirty database block instances for eviction and writeback, writeback cache 180 may together writeback both dirty database block instances even though only one of the dirty database block instances is evicted and the other is retained. Thus, writeback of multiple dirty database block instances might require only a single write of a single disk block, which accelerates components 111, 120-121, and 125.

In another scenario, two adjacent disk blocks each contains a respective database block, and writeback cache 180 contains dirty database block instances of both database blocks. When writeback cache 180 selects one of the two dirty database block instances for eviction and writeback, writeback cache 180 may together writeback both dirty database block instances even though only one of the dirty database block instances is evicted and the other is retained. Thus, writeback of multiple dirty database block instances in adjacent disk blocks requires only a single sequential disk write spanning multiple adjacent disk blocks, which accelerates components 111, 120-121, and 125.

Whether a read or a write, access request 181 contains a database block address of a database block. Whether reading or writing, a cache hit occurs if writeback cache 180 contains a dirty or non-dirty replica of the database block. Whether reading or writing, a cache miss occurs if writeback cache 180 does not contain a dirty or non-dirty replica of the database block. Whether reading or writing, if a miss occurs when writeback cache 180 is full, then eviction occurs.

If writeback cache 180 is full and proactive writeback has not occurred or is unimplemented, then eviction of dirty database block instance 153 causes writeback of dirty database block instance 153. As discussed above, if writeback cache 180 is full and proactive writeback of a database block instance already rendered the database block instance non-dirty before the database block instance is selected for eviction, then eviction of the database block instance does not entail writeback, and that avoidance accelerates the eviction.

### 1.6 DELTA STAGING REGION

Replicas of multiple database blocks may be stored in any of storage media 141-142 and 145. In various examples, some or all of database block instances 151-155 are or are not instances of a same database block. Herein, all transfers of a database block instance to, from, or within storage computer 111 entail at least temporarily storing the database block instance in volatile memory 145, shown as database block instance 155.

As discussed later herein, delta staging region 190 is a dynamically generated (i.e. reserved or allocated) disk space that is a separate disk space than database replica 121. Delta staging region 190 is dynamically generated during repair of a damaged extent such as individual database extent 101 or, as discussed later herein, a database extent group. Delta staging region 190 does not have capacity to store whole database replica 121, and database replica 121 does not contain delta staging region 190. Herein, a database block in delta staging region 190 is referred to as a staged database block, and all staged database blocks are dirty (i.e. absent or different in database replica 121).

Delta staging region 190 is a temporary persistence space that is generated solely for repairing a particular database extent or database extent group. While delta staging region 190 exists: a) no database block instances in write requests to storage computer 111 are persisted into database replica 121, and b) all database block instances in write requests to storage computer 111 are instead persisted into delta staging region 190. After all lost database blocks in the database extent or database extent group are repaired, then de-staging occurs that, as discussed later herein, performs in sequence: 1) all database block instances in delta staging region 190 are persisted into database replica 121, and 2) delta staging region 190 is deleted (i.e. deallocated). This temporary diversion of write requests ensures that a resilver process discussed later herein has exclusive write access to database replica 121 without taking database replica 121 out of service. In other words as discussed later herein, database replica 121 remains in service throughout the resilver (i.e. repair) process.

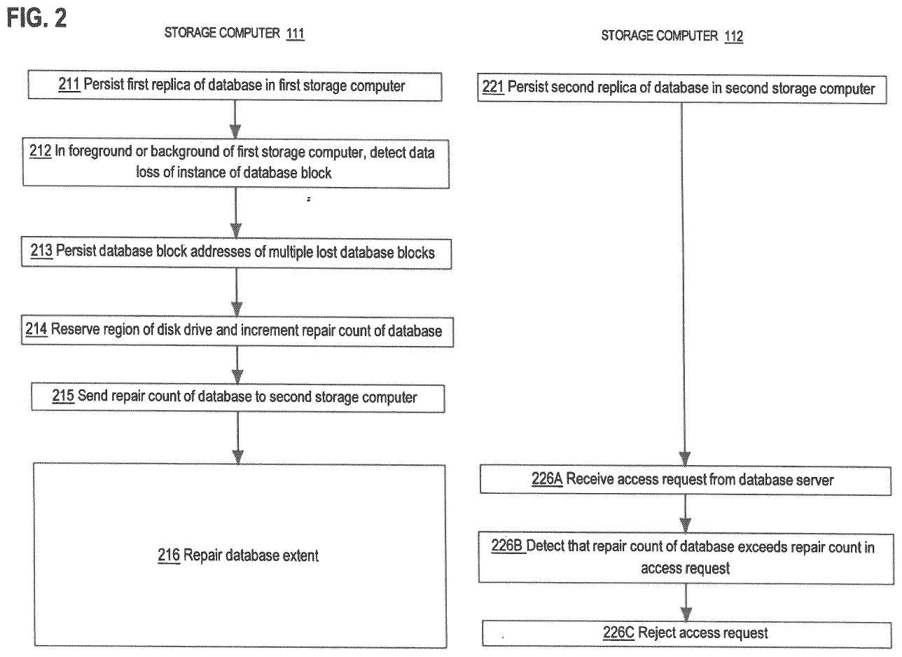

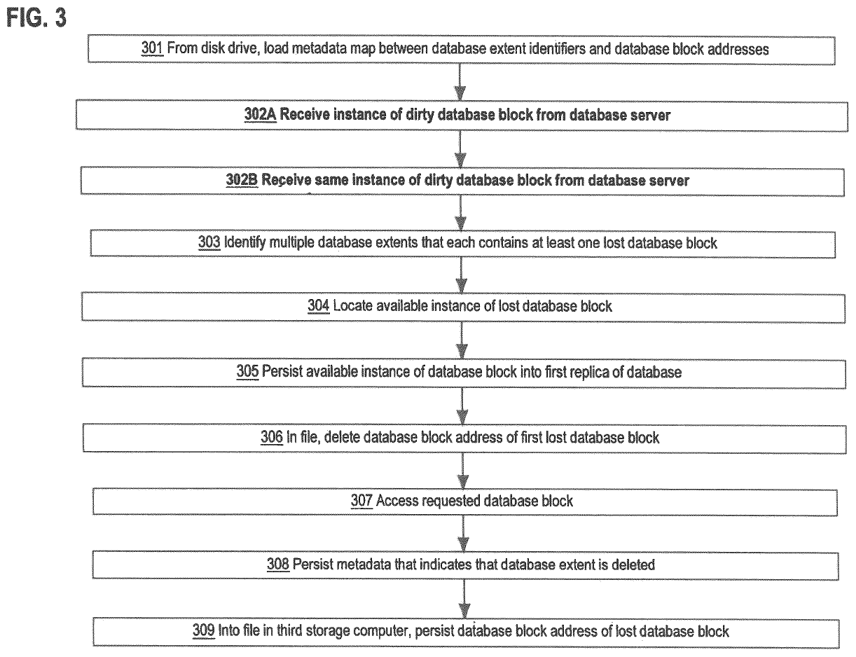

As discussed later herein, repair count 191 is a global counter that is incremented when a delta staging region is generated. As discussed later herein, metadata map 170 tracks which database extents contain which database blocks. Data loss components 170 and 190-191 are special components for handling data loss. Cooperation of data loss components 170 and 190-191 is discussed for FIGS. 2-3 as follows.

### 2.0 Example Concurrent Processes for Coherence of All Database Replicas

FIG. 2 is a flow diagram that depicts two concurrent example independent processes that are a left example process comprising steps 211-216 and a right example process comprising steps 221 and 226A-C. Storage computers 111-112 may respectively perform the left example process and the right example process. The left example process resilvers in the background without data loss while the right example process maintains data coherence for database replicas 121-122 of database 120 that remain in service.

Steps 211 and 221 persist respective database replicas 121-122 in respective storage computers 111-112. Much time may elapse after steps 211 and 221, and either or both of storage computers 111-112 may, in some examples, reboot before performance of steps 212 and 226A. However, when step 212 occurs, the left and right example processes execute the remaining steps as follows.

### 2.1 Discovery Process is Part of Left Process

Step 212 detects data loss of a replica of a database block for database 120. Which database block is involved and in which of storage drives 141-142 depends on which of a reactive scenario or a proactive scenario occurs as follows. Although shown as a single process, the left example process includes a discovery process comprising steps 212-213 followed by a resilver process comprising steps 214-216. As follows, the discovery process discovers data loss by detecting a failed access request or bad device block(s).

Storage computer 111 executes access request 181 in a foreground process that, in the reactive scenario, includes the discovery process in which step 212 unsuccessfully attempts to access a database block to fulfill access request 181. For example, step 212 may attempt to read or write either of database block instances 151 or 153, which may fail according to some device error from either of storage drives 141-142, such as a checksum error.

In the reactive scenario, step 212 may send, to database server 125, a retry response (not shown) to access request 181 that indicates that access request 181 should be resent elsewhere (i.e. not storage computer 111). As discussed later herein, database replica 121 remains in service even though step 212 sends a retry response.

In the proactive scenario, step 212 is autonomous and, in a background process that is asynchronous and independent of execution of access requests, step 212 write tests device blocks to discover failed device blocks in either of storage drives 141-142. In an embodiment, step 212 only tests a device block if the device block contains a database block, such as either of database block instances 151 or 153. If a device block passes a write test, the device block contains the same data before and after the write test.

As discussed above, step 212 occurs either in a foreground process or a background process, and steps 212-213 occur in the same process. Step 213 is streamlined for maximum acceleration of the discovery process. Into file 185 in disk drive 142, step 213 persists database block addresses 161-162 of multiple lost database blocks. In an embodiment, step 213 performs a separate write to individually write each of database block addresses 161-162 into file 185.

For acceleration of the discovery process, the discovery process and the resilver process are asynchronously decoupled from each other. That is, completion of step 213 does not immediately (i.e. synchronously) cause step 214.

### 2.2 Resilver Process is Part of Left Process

In some embodiments, the resilver process periodically checks whether file 185 exists or contains a database block address (of a lost database block). In the absence of file 185, the resilver process is inactive and, when file 185 is detected, the resilver process performs the remaining steps as follows. The resilver process is a background process and when the discovery process also is a background process as discussed above, then these are two distinct background processes.

As discussed earlier and later herein, step 214 generates (i.e. reserves) delta staging region 190 that is initially empty (i.e. not containing data structures 154 and 175). In various embodiments: a) delta staging region 190 has a fixed size that never changes and/or b) delta staging region 190 has a size based on a count of database blocks that are lost in an individual database extent or, as discussed later herein, lost in a database extent group.

Step 214 increments repair count 191 of database 120, and step 215 sends repair count 191 to storage computer 112. For example, step 215 may broadcast repair count 191 to all other storage computers 112-113.

Herein, every database block is contained in exactly one database extent. Herein, a database extent that contains a database block that has lost data is referred to as a damaged extent. As discussed later herein, a database extent may be an individual database extent or a database extent group that contains multiple individual database extents. Depending on the example, individual database extents 101-102 may or may not be in a same database extent group.

Depending on the embodiment, step 216 repairs one individual database extent or one database extent group that contains multiple individual database extents. Activities for repairing a database extent are discussed later herein. Step 216 finishes by performing de-staging that entails applying (i.e. copying) delta staging region 190 into database replica 121 and then deleting delta staging region 190 as discussed later herein. Before de-staging begins, steps 226A-C on storage computer 112 are concurrent to step 216 on storage computer 111 as follows.

### 2.3 Data Coherence for All Database Replicas Facilitated by Right Process

For database 120, step 226A receives access request 182 from database server 125. Herein, all write requests contain a respective repair count. Step 226B detects that repair count 191 of database 120 exceeds repair count 192 in access request 182 and, in that case, step 226C rejects access request 182 and sends, back to database server 125, a retry response that indicates that access request 182 should be resent (e.g. broadcast) to all storage computers. In an embodiment, the retry response contains repair count 191, and database server 125 may: a) in access request 182, replace repair count 192 with repair count 191 that is higher and more recent and then b) resend access request 182 to storage computers 111-112.

As discussed later herein, database replicas 121-122 remain in service even though step 226C sends a retry response. Receiving a retry response from step 212 or 226C does not cause execution of a database statement or database transaction to fail. Database server 125 resends access requests when suggested by storage computers, and these resends maintain correctness of operation of database server 125.

### 3.0 Example Data Coherence Activities

FIG. 3 is a flow diagram that depicts example activities that storage computers 111-113 may perform while storage computer 111 resilvers in the background without data loss while database replicas 121-122 of database 120 remain in service. For ease of demonstration, one storage computer 111 performs all of steps 301-309 as follows.

Initialization step 301 may occur while starting storage computer 111. From disk drive 142 into volatile memory 145, step 301 copies or otherwise loads metadata map 170 that is a mapping between database extent identifiers and database block addresses. For example, database blocks 103-104 may be respectively identified by database block addresses B1-B2 that metadata map 170 associates with database extent identifier E2 that identifies database extent 101. In other words, metadata map 170 indicates that database extent 101 contains database blocks 103-104.

FIGS. 2-3 may be related as follows. Data loss, the discovery process, steps 226A-C, and initiation of the resilver process occur between steps 302A-B that are shown bold to indicate that much behavior herein occurs between steps 302A-B. Each of steps 302A-B receives a distinct instance of a same write request. Each of both write request instances contains a respective distinct repair count and is generated and sent by database server 125 at separate times. The second write request instance occurs in reaction to the retry response that was generated and sent by step 226C.

In a write access request, step 302A receives a dirty instance of database block 103 from database server 125. The discovery process discussed earlier herein may be ongoing or finished when step 302A occurs. Step 302A occurs before the resilver process begins. This special and incidental timing of the write access request of step 302A causes data loss in the state of the art as follows.

Step 302A occurs before step 214 in FIG. 2 creates delta staging region 190 and before step 214 increments repair count 191. Step 302A detects that delta staging region 190 does not exist (i.e. because no data is yet lost) and persists the dirty database block into database replica 121, shown as database block instance 151 that, in this example, is an instance of database block 103. However, database block instance 151 may soon be overwritten by a stale instance of same database block 103 as discussed later herein.

In this example, data loss between steps 302A-B is caused by a crash of solid state drive 141. In other words, solid state drive 141 becomes unavailable. Steps 302B-309 occur while database components 120-122 remain in service, regardless of whether or not solid state drive 141 eventually becomes available again.

In a write access request from database server 125, step 302B receives the same dirty instance of database block 103 that was in the write request of step 302A. Step 302B occurs after the discovery process has finished and the resilver process has already begun. This special and intentional timing of the write access request of step 302B is an innovative way to prevent data loss as follows.

Step 302B occurs after step 214 in FIG. 2 creates delta staging region 190 and after step 214 increments repair count 191. Step 302B detects that delta staging region 190 exists (i.e. because the resilver process is ongoing), which causes step 302B to persist the dirty database block into delta staging region 190, shown as database block instance 154 that, in this example, is an instance of database block 103. In this example, database block instance 154 is identical to database block instance 151 that may soon be overwritten by a stale instance of same database block 103 as discussed later herein. It does not matter if database block instance 151 is overwritten with stale data because, as discussed later herein, using database block instance 154 is a novel way that will be used to reestablish database block instance 151.

### 3.1 Resilvering Occurs

The resilver process discussed earlier herein performs steps 303-306 as follows. As discussed earlier herein, step 303 uses metadata map 170 to identify multiple database extents 101-102 that each has lost at least one database block. For example: a) database extent identifiers E1-E2 may respectively identify database extents 101-102, and b) file 185 may contain database block addresses A1, A3, and B2 but not A2, B1, and C1. In that case, step 303 detects that: a) database extent identifier E3 identifies a database extent in database 120 that is not damaged and b) database extents 101-102 are damaged (i.e. have lost database blocks).

Step 304 locates an available instance of a lost database block of a damaged extent. For step 304, it does not matter which of storage drives 141-142 lost the database block and it does not matter whether the lost instance of the database block was dirty or not. For example, file 185 may contain database block addresses of a mix of dirty database blocks lost by solid state drive 141 and non-dirty database blocks lost by disk drive 142.

As discussed earlier herein, step 215 of FIG. 2 may broadcast repair count 191 to all other storage computers 112-113. In FIG. 3, step 304 selects one of other storage computers 112-113 to provide an available instance of the lost database block of the damaged extent.

As discussed above, based on data structures 170 and 185, steps 303-304 know which damaged extents include which lost database blocks. Step 304 may send to storage computer 112 a copy request to obtain a copy of: a) storage computer 112's available instance of a lost database block, b) storage computer 112's available instances of multiple lost database blocks in an individual damaged extent, or c) storage computer 112's available instances of multiple lost database blocks in a group of individual damaged extents as discussed earlier herein. A copy request contains database block addresses of one or more lost database blocks. A copy request does not contain a database extent identifier.

Storage computer 112 responds to a copy request by sending, back to storage computer 111, a copy response (not shown) that contains copies of available instances of one or more lost database blocks as requested. A copy response does not contain a database block that was not lost. When containing a database block, a copy response, in an embodiment, indicates none of: a) whether the database block is dirty or not, b) whether the database block was obtained from a writeback cache or not, and c) a resilver count.

When step 305 receives a copy response, step 305 may perform either or both of: a) based on data structures 170 and 185, detecting which received database blocks in the copy response belong in which damaged extents and b) persist received database blocks into the database extents in database replica 121 regardless of which of storage drives 141-142 lost the database block. If step 305 receives a stale (i.e. not current) instance of database block 103, then step 305: a) does not detect the received database block instance is stale and b) persists the stale database block instance in database replica 121 even though this c) overwrites latest database block instance 151. In the state of the art, such overwriting of latest data with stale data would cause data loss but does not in this approach as discussed later herein.

In file 185, to maximize the accuracy of file 185, step 306 immediately deletes an individual database block address of an individual database block as soon as step 305 finishes persisting the individual database block into database replica 121. In other words, file 185 always precisely reflects the progress of the resilver process, which facilitates step 309 discussed later herein.

As discussed above, step 303 identified multiple damaged extents and may have grouped them into multiple database extent groups. Storage computer 111 repairs (i.e. repeats steps 214-216 of FIG. 2 and 304-306 of FIG. 3) for each database extent group that is damaged, one database extent group at a time, in sequence. For example, step 306 may occur for a first database extent group before step 304 occurs for a second database extent group. Step 304 may send a separate copy request, for example in a separate network message, for each database extent group that is damaged.

### 3.2 Staging Occurs Concurrent to Resilvering

In one example, access request 181 is a read request. In that case, access request 181 does not contain a repair count. Behavior of step 307 that receives read access request 181 is contextual as follows.

If delta staging region 190 contains an instance of a database block being read by step 307, then this is a staging hit, and that instance of the database block is used to fulfil the read even though the instance is dirty (i.e. not in database replica 121). If staging region 190 does not contain an instance of a database block being read by step 307, then this instead is a staging miss.

Step 307 reacts to a staging miss as follows. In an embodiment, a staging miss causes step 307 to send a retry response that indicates that access request 181 should be resent elsewhere (i.e. not storage computer 111). In an accelerated embodiment, a staging miss instead causes step 307 to react based on metadata map 170 as follows.

When access request 181 attempts to read a requested database block, step 307: a) uses metadata map 170 to detect which database extent contains the requested database block and b) uses file 185 to detect whether or not the database extent is a damaged extent, regardless of whether or not the requested database block is lost. If the requested database block is in a damaged extent, then step 307 sends a retry response as discussed above for step 307. If the requested database block is not in a damaged extent, then the accelerated embodiment of step 307 instead: a) reads database block instance 151 as requested and b) sends a copy of database block instance 151 in a read response to database server 125.

In the example discussed above for steps 302 and 305: a) database block instance 151 is a latest (i.e. current) instance of database block 103, b) step 302 persisted latest database block instance 151 into database replica 121, and c) step 305 overwrote latest database block instance 151 with stale data. Also as discussed earlier herein, latest database block instances 151 and 154 were identical until database block instance 151 was overwritten with stale data. In an extreme example of racing that does not impact correctness, database block instance 151 is overwritten before storage computer 111 receives database block instance 154, which means that temporarily storage computer 111 does not contain the latest instance of database block 103 until database server 125 resends database block instance 154 in a retried write request as discussed above for step 302B.

Because this approach guarantees that database server 125 retries the write request, storage computer 111 is guaranteed to eventually receive the latest instance of database block 103. Handling of the eventually-received latest instance of database block 103 is contextual as follows. If delta staging region 190 exists, then the resilver process is still ongoing, in which case the eventually-received latest instance of database block 103 is persisted into delta staging region 190, shown as dirty database block instance 154. If delta staging region 190 does not exist, then the resilver process finished, and the eventually-received latest instance of database block 103 is instead persisted into database replica 121, shown as database block instance 151. Finishing the resilver process is discussed later herein.

### 3.3 Delete Request

Either of database components 101 or 103 may be individually deleted, such as when access request 181 is a delete request. When step 308 receives a delete request to delete database component 101 or 103, then step 308: a) removes the identifier or address of the database component from metadata map 170 and b) persists metadata map 170 in disk drive 142. In other words, metadata map 170 always is current in storage components 142 and 145.

Behavior of step 308 is contextual as follows. In the shown example, step 308 occurs while the resilver process is ongoing and delta staging region 190 exists. In other examples, step 308 occurs before data loss or after the resilver process, when delta staging region 190 does not exist. If delta staging region 190 does not exist, step 308 deletes database component 101 or 103 from database replica 121 as requested. If delta staging region 190 exists, step 308 generates and persists deletion metadata 175 that indicates deletion of database component(s) identified by the delete request. Deletion metadata 175 contains identifiers or addresses of deleted database component(s).

If deletion of database block 103 is requested and delta staging region 190 contains database block 103, then step 308 deletes database block 103 from delta staging region 190, shown as dirty database block instance 154. If deletion of database extent 101 is requested, then step 308: a) deletes, from delta staging region 190, all database blocks that are contained in both (i.e. conjunction, set intersection) of database components 101 and 190, regardless of whether database extent 101 is damaged or not and b) into deletion metadata 175, persists database block addresses of all database blocks 103-104 in deleted database extent 101.

### 3.4 De-Staging Occurs

The resilver process finishes by performing a de-staging process as follows. All database blocks in delta staging region 190 are persisted into database replica 121. Deletion metadata 175 is applied to database replica 121 by deleting, in database replica 121, any database blocks and database extents whose identifiers or addresses are contained in deletion metadata 175. The de-staging process finishes by deleting (i.e. deallocating) delta staging region 190. Various behaviors of storage computer 111 are conditioned on the presence or absence of delta staging region 190 as discussed earlier herein.

As discussed earlier herein, step 305 might have overwritten, in database replica 121, latest database block instance 151 with a stale instance of the same database block. Also as discussed earlier herein, storage computer 111 is guaranteed to eventually receive the latest database block instance in a retry of a write request, and that received latest database block instance is persisted, depending on the context (i.e. timing, racing), in one of storage spaces 121 and 190. If the eventually received latest database block instance is persisted into delta staging region 190, then de-staging reestablishes the latest database block instance in database replica 121. In those ways, any data loss in storage components 121 and 180 is guaranteed to be temporary and guaranteed not to cause any of database replicas 121-122 to become out of service.

### 3.5 Interruption, Relocation, and Resumption of Resilver Process

Per earlier step 306, persistent file 185 always precisely reflects the progress of the resilver process. Thus if de-staging has not yet occurred, the resilver process is interruptible and, in the following beneficial scenarios, the resilver process can later be resumed.

In an unplanned scenario, storage computer 111 crashes while performing the resilver process and reboots. The resilver process is, based on file 185, seamlessly resumed and finished. A planned scenario also provides resumption based on file 185 as follows.

For whatever reason such as capacity planning or rebalancing, whether autonomous or administrated, distributed system 100 decides or is requested to relocate damaged database extent 101 from storage computer 111 to storage computer 113. Copying or moving of a damaged database extent is novel and supported as follows.

For example, storage computer 113 may be newly provisioned, and step 309 occurs as follows. Step 309 copies database replica 121, whether damaged or not, and delta staging region 190 to new storage computer 113 that receives and persists the copy of the database replica and the copy of the delta staging region. Into a persistent file in storage computer 113, step 309 persists a database block address of a database block that storage computer 111 lost. In an embodiment, step 309 sends a copy of file 185 to storage computer 113 that receives and persists the copy of the file. As soon as step 309 finishes: a) storage computer 113 may resume the resilver process as discussed above and b) storage computer 111 may be taken out of service or remain in service and continue the resilver process. For example, storage computers 111 and 113 may, after step 309, both independently perform the same remainder of the resilver process.

The activities and steps of FIGS. 2-3 may be combined or interleaved in various ways in various embodiments or scenarios. In ways discussed earlier herein and while storage computer 111 performs step 216 of FIG. 2, a particular storage computer may perform any of the following various storage activities. Storage computer 111 may move a damaged database extent from database replica 121 to storage computer 113. From database server 125, storage computer 111 or 112 may receive a dirty instance of a lost or non-lost database block. In a copy response, storage computer 111 may receive a stale version of a database block from storage computer 112. Into disk drive 142, storage computer 111 may persist an instance of a database block that storage computer 111 lost. From disk drive 142, storage computer 111 may retrieve a database block that storage computer 111 lost. Into database replica 122, storage computer 112 may persist an instance of a database block that storage computer 111 lost. All of those various storage activities may occur current to step 216.

### 4.0 Database System Overview

A database management system (DBMS) manages one or more databases. A DBMS may comprise one or more database servers. A database comprises database data and a database dictionary that are stored on a persistent memory mechanism, such as a set of hard disks. Database data may be stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement that conforms to a database language. A database language for expressing the database commands is the Structured Query Language (SQL). There are many different versions of SQL, some versions are standard and some proprietary, and there are a variety of extensions. Data definition language (“DDL”) commands are issued to a database server to create or configure database objects, such as tables, views, or complex data types. SQL/XML is a common extension of SQL used when manipulating XML data in an object-relational database.

A multi-node database management system is made up of interconnected nodes that share access to the same database or databases. Typically, the nodes are interconnected via a network and share access, in varying degrees, to shared storage, e.g. shared access to a set of disk drives and data blocks stored thereon. The varying degrees of shared access between the nodes may include shared nothing, shared everything, exclusive access to database partitions by node, or some combination thereof. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

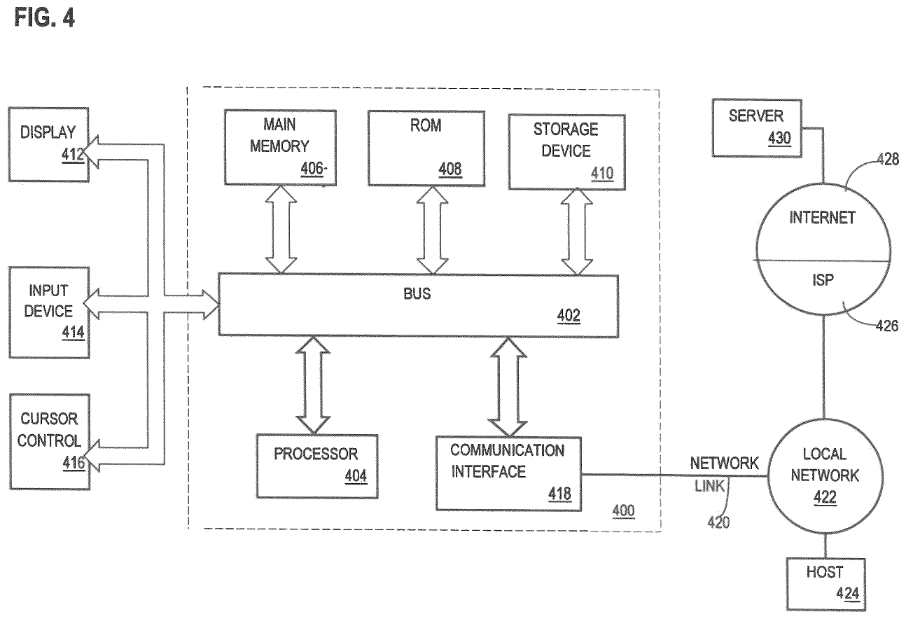

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet”428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

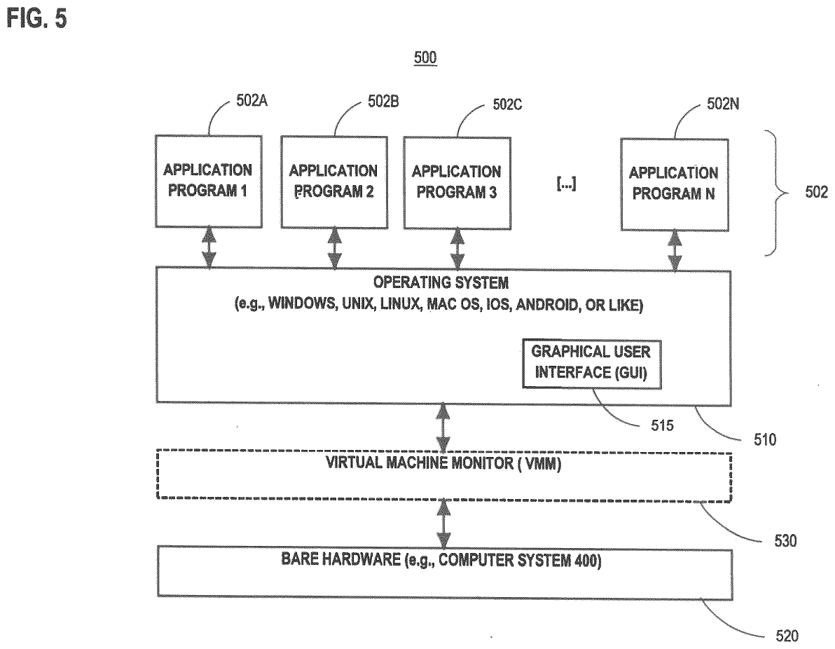

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 500 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include:
Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
persisting a first replica of a database in a first storage computer and a second replica of the database in a second storage computer, wherein the database contains a database extent that contains a database block;
incrementing, by the first storage computer, in response to detecting a data loss of an instance of said database block in a storage drive in the first storage computer, a repair count of the database;
concurrently:
repairing the database extent, and
detecting, by the second storage computer, that the repair count of the database exceeds a repair count in a write request; and
rejecting, in response to said detecting, the write request.

2. The method of claim 1 wherein the storage drive is:
a) a disk drive that contains the database or
b) a solid-state drive (SSD) that contains a persistent writeback cache that contains the instance of the database block, wherein the SSD does not have capacity to store the database.

3. The method of claim 1 further comprising in a file in a disk drive, before said incrementing, persisting database block addresses of a plurality of lost database blocks that include at least one selected from a group consisting of: a) a dirty database block in a persistent writeback cache and b) in a disk drive, a database block that is not dirty.

4. The method of claim 3 wherein the plurality of lost database blocks include: a) a dirty database block in a persistent writeback cache and b) in a disk drive and not in the persistent writeback cache, a database block that is not dirty.

5. The method of claim 3 wherein:
the method further comprises detecting, by a background process in the first storage computer, the file;
said incrementing is in response to said detecting the file.

6. The method of claim 5 further comprising:
in response to said detecting the file, reserving a region of the disk drive, wherein:
the first replica of a database does not include the region of the disk drive, and
the region of the disk drive does not have capacity to store the database;
in response to a second access request from a database server during said repairing, accessing a particular database block selected from a group consisting of:
a database block in the region of the disk drive and
a database block that the region of the disk drive does not contain.

7. The method of claim 6 further comprising by the first storage computer concurrent to said repairing, in the region of the disk drive in response to a deletion request from a database server, storing metadata that indicates that the database extent is deleted.

8. The method of claim 6 wherein a size of the region of the disk drive is at least one size selected from a group consisting of:
a fixed size that never changes for the region of the disk drive and a size based on a count of the plurality of lost database blocks.

9. The method of claim 6 wherein said reserving occurs before said incrementing.

10. The method of claim 5 further comprising in response to said detecting the file, identifying a plurality of database extents that each contains at least one database block of the plurality of lost database blocks.

11. The method of claim 3 wherein each database block address of the plurality of lost database blocks contains a physical block address of a disk block and a file identifier.

12. The method of claim 3 wherein said repairing is based on the file and the database block addresses of the plurality of lost database blocks.

13. The method of claim 3 wherein:
the plurality of lost database blocks comprises a first lost database block and a second lost database block;
said repairing comprises without deleting, in the file, the database block address of the second lost database block, performing in sequence:
in the file, deleting the database block address of the first lost database block, and
locating an available replica of the second lost database block.

14. The method of claim 13 further comprising after said locating, storing the available instance of the database block into the first replica of the database.

15. The method of claim 3 further comprising into a file in a third storage computer during said repairing, persisting the database block address of a lost database block of the plurality of lost database blocks, wherein the database block address includes a physical block address of a disk block in the third storage computer.

16. The method of claim 3 further comprising from a disk drive, loading a metadata map between database extent identifiers and database block addresses of database blocks in the database.

17. The method of claim 16 wherein:
the metadata map associates:
a first database extent identifier with a first plurality of database block addresses and
a second database extent identifier with a second plurality of database block addresses;
the method further comprises sending to the second storage computer:
a first message that contains at least two of the first plurality of database block addresses and
a second message that contains at least two of the second plurality of database block addresses;
the first message does not contain a of database block address of the second plurality of database block addresses;
the second message does not contain a of database block address of the first plurality of database block addresses.

18. The method of claim 1 further comprising after said incrementing, sending the repair count of the database to the second storage computer.

19. The method of claim 1 further comprising detecting, by a background process in the first storage computer, said data loss of the instance of the database block.

20. The method of claim 1 wherein the instance of the database block is a version of the database block that is contained in none of: the first replica of the database and the second replica of the database.

21. The method of claim 1 further comprising during said repairing, performing at least one storage action selected from a group consisting of:
a) movement of the database extent from the first replica of the database to a third storage computer,
b) receipt, by the first storage computer or the second storage computer, of the instance of the database block from a database server,
c) receipt, by the first storage computer, of a stale version of the database block from the second storage computer,
d) storage, by the first storage computer or the second storage computer, of the instance of the database block into a disk drive,
e) retrieval, by the first storage computer, of the instance of the database block from a disk drive, and
f) storage of the instance of the database block into the second replica of the database.

22. The method of claim 1 wherein:
the method further comprises receiving the write request from a database server;
said rejecting comprises to the database server, sending a response that indicates that the write request should be resent.

23. One or more computer-readable non-transitory media storing instructions that, when executed by one or more computers, cause:
persisting a first replica of a database in a first storage computer and a second replica of the database in a second storage computer, wherein the database contains a database extent that contains a database block;
incrementing, by the first storage computer, in response to detecting a data loss of an instance of said database block in a storage drive in the first storage computer, a repair count of the database;
concurrently:
repairing the database extent, and
detecting, by the second storage computer, that the repair count of the database exceeds a repair count in a write request; and
rejecting, in response to said detecting, the write request.

24. The one or more computer-readable non-transitory media of claim 23
wherein the storage drive is:
a) a disk drive that contains the database or
b) a solid-state drive (SSD) that contains a persistent writeback cache that contains the instance of the database block, wherein the SSD does not have capacity to store the database.

25. The one or more computer-readable non-transitory media of claim 23 wherein the instructions further cause in a file in a disk drive, before said incrementing, persisting database block addresses of a plurality of lost database blocks that include at least one selected from a group consisting of: a) a dirty database block in a persistent writeback cache and b) in a disk drive, a database block that is not dirty.

26. The one or more computer-readable non-transitory media of claim 25 wherein the plurality of lost database blocks include: a) a dirty database block in a persistent writeback cache and b) in a disk drive and not in the persistent writeback cache, a database block that is not dirty.

27. The one or more computer-readable non-transitory media of claim 25 wherein:
the instructions further cause detecting, by a background process in the first storage computer, the file;
said incrementing is in response to said detecting the file.

28. The one or more computer-readable non-transitory media of claim 27 wherein the instructions further cause:
in response to said detecting the file, reserving a region of the disk drive, wherein:
the first replica of a database does not include the region of the disk drive, and
the region of the disk drive does not have capacity to store the database;
in response to a second access request from a database server during said repairing, accessing a particular database block selected from a group consisting of:
a database block in the region of the disk drive and
a database block that the region of the disk drive does not contain.
